(19) United States
(12) Patent Application Publication
(10) Pub. No.: US 2026/0370244 A1
(43) Pub. Date: Nov. 19, 2026

(54) RADIO FREQUENCY MODULE AND COMMUNICATION DEVICE

(71) Applicant: Murata Manufacturing Co., Ltd., Kyoto (JP)

(72) Inventors: Kensuke TAKIMOTO, Kyoto (JP); Shogo YANASE, Kyoto (JP); Kazuhiro TAKAHASHI, Kyoto (JP)

(73) Assignee: Murata Manufacturing Co., Ltd., Kyoto (JP)

(21) Appl. No.: 19/667,687

(22) Filed: May 5, 2026

(30) Foreign Application Priority Data
May 19, 2025 (JP) 2025-083572

(51) Int. Cl. H04B 1/00; H04B 1/04

(52) U.S. Cl. CPC H04B 1/0078; H04B 1/0483; H04B 2001/0408

(57) ABSTRACT

A radio frequency module includes a mounting substrate, a first IC chip in or on the mounting substrate, the first IC chip including a first power amplifier and a second power amplifier, and a first balun in or on the mounting substrate, the first balun including a primary coil connected between an output terminal of the first power amplifier and an output terminal of the second power amplifier, wherein an outer periphery of the first IC chip has a polygonal shape with a first side and a second side that differ from each other, the output terminal of the first power amplifier is disposed along the first side, the output terminal of the second power amplifier is disposed along the second side, and the primary coil intersects with the first side and the second side.

### CROSS-REFERENCE TO RELATED APPLICATION

This application claims priority to Japanese Patent Application No. 2025-083572, filed on May 19, 2025. The entire contents of the above-listed application is incorporated herein by reference.

### BACKGROUND

### 1. Field

The present disclosure generally relates to a radio frequency module and a communication device, and more specifically, to a radio frequency module that includes a balun, and a communication device that includes a radio frequency module.

### 2. Description of the Related Art

International Publication No. 2022/009748 discloses a radio frequency module that includes a substrate, a first chip, a second chip, a first transformer, and a second transformer. The first chip and the second chip are disposed on a mounting surface of the substrate. The first transformer and the second transformer are formed in the substrate. The radio frequency module disclosed in International Publication No. 2022/009748 includes the first chip with a first amplification element and a second amplification element that amplify a first transmission signal, and the second chip with a third amplification element and a fourth amplification element that amplify a second transmission signal. The first transformer includes a coil that is connected between an output terminal of the first amplification element and an output terminal of the second amplification element. The second transformer includes a coil that is connected between an output terminal of the third amplification element and an output terminal of the fourth amplification element.

### SUMMARY

A radio frequency module according to an aspect of the present disclosure includes a mounting substrate, a first IC chip in or on the mounting substrate, the first IC chip including a first power amplifier and a second power amplifier, and a first balun in or on the mounting substrate, the first balun including a primary coil connected between an output terminal of the first power amplifier and an output terminal of the second power amplifier, wherein an outer periphery of the first IC chip has a polygonal shape in a plan view in a thickness direction of the mounting substrate, the polygonal shape having a first side and a second side that differ from each other, the output terminal of the first power amplifier is disposed along the first side in the plan view in the thickness direction of the mounting substrate, the output terminal of the second power amplifier is disposed along the second side in the plan view in the thickness direction of the mounting substrate, and the primary coil of the first balun intersects with the first side and the second side in the plan view in the thickness direction of the mounting substrate.

### BRIEF DESCRIPTION OF THE DRAWINGS

FIG. 1 illustrates a plan view of a radio frequency module according to a first embodiment;

FIG. 2 schematically illustrates a perspective view of the radio frequency module;

FIG. 3 is a circuit diagram of the radio frequency module;

FIG. 4 illustrates a plan view of a radio frequency module according to a second embodiment;

FIG. 5 schematically illustrates a perspective view of the radio frequency module;

FIG. 6 illustrates a plan view of a radio frequency module according to a third embodiment;

FIG. 7 schematically illustrates a perspective view of the radio frequency module; and

FIG. 8 is a block diagram of a communication device according to a fourth embodiment.

### DESCRIPTION OF EMBODIMENTS

In the radio frequency module disclosed in International Publication No. 2022/009748, the exclusive areas of a balun and a power amplifier in an amplification device that includes two amplification elements that perform a paired operation are likely to increase in the case where output terminals of the amplification elements are disposed along a common side of an IC chip that includes the amplification device.

The present disclosure has been accomplished in view of the matters described above, and an aspect of the present disclosure provides a radio frequency module and a communication device that enable the exclusive areas of a balun and a power amplifier to be reduced.

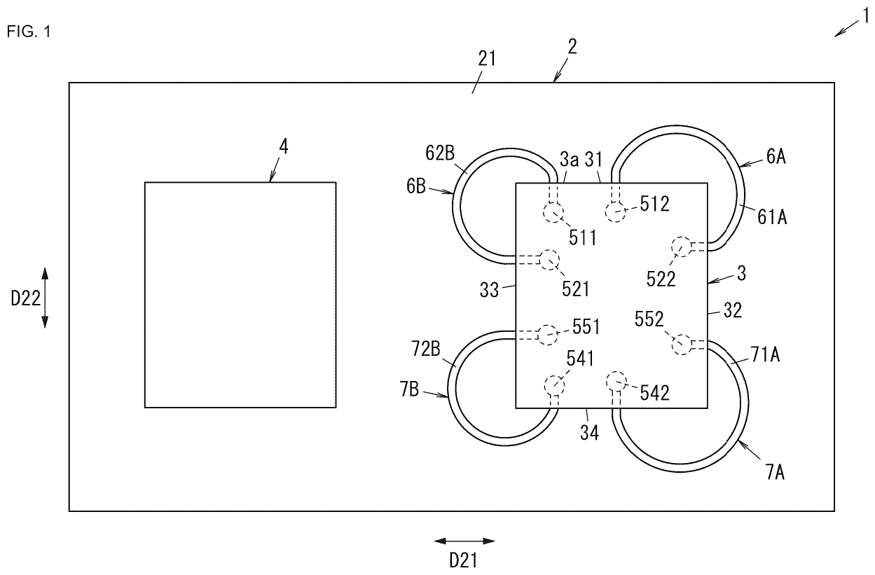

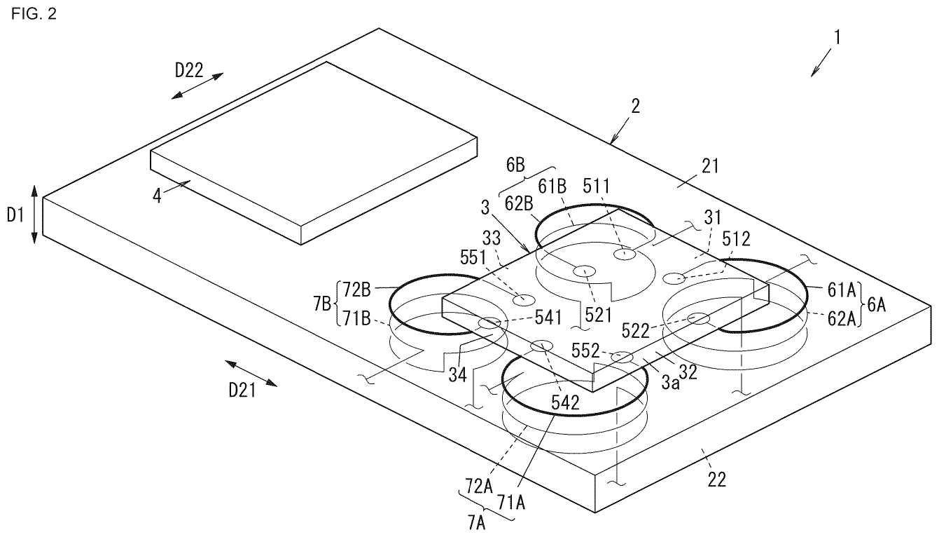

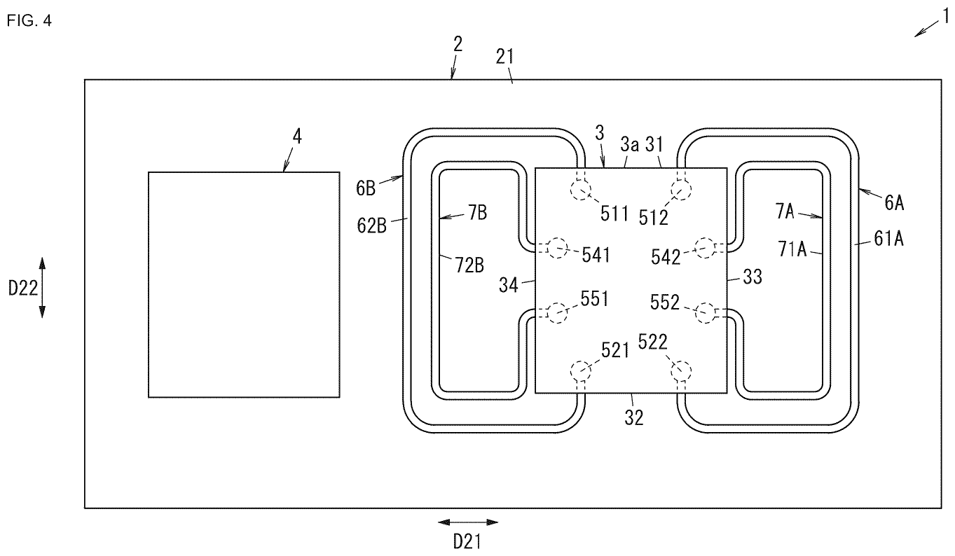

Radio frequency modules 1 according to first to third embodiments and a communication device 9 according to a fourth embodiment will hereinafter be described with reference to the drawings. FIG. 1, FIG. 2, and FIG. 4 to FIG. 7 referred to according to, for example, the embodiments described below are schematically illustrated, and ratios of the thicknesses and sizes of components in the figures do not necessarily represent actual ratios.

### First Embodiment

### (1) Radio Frequency Module

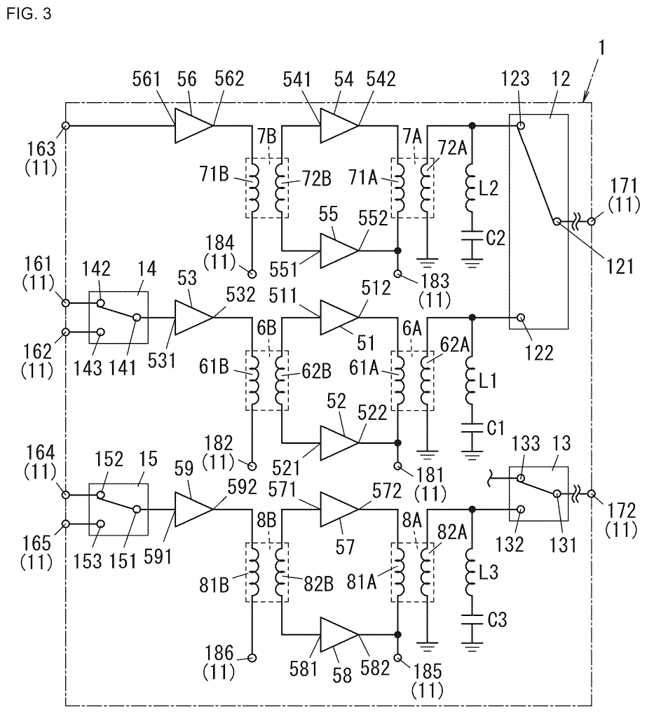

As illustrated in FIG. 1, the radio frequency module 1 according to the first embodiment includes a mounting substrate 2, a first integrated circuit (IC) chip 3, and a first balun 6A. The first IC chip 3 is disposed in or on the mounting substrate 2 and includes a first power amplifier 51 and a second power amplifier 52 (see FIG. 3). The first balun 6A is disposed in or on the mounting substrate 2. The first balun 6A includes a primary coil 61A. The primary coil 61A is connected between an output terminal 512 of the first power amplifier 51 and an output terminal 522 of the second power amplifier 52. An outer periphery 3a of the first IC chip 3 has a polygonal shape in plan view in a thickness direction D1 (see FIG. 2) of the mounting substrate 2 and has a first side 31 and a second side 32 that differ from each other (e.g., the first side 31 and the second side 32 may be different sides of the polygonal shape and at different positions on the mounting substrate 2). The output terminal 512 of the first power amplifier 51 is disposed along the first side 31 in plan view in the thickness direction D1 of the mounting substrate 2. The output terminal 522 of the second power amplifier 52 is disposed along the second side 32 in plan view in the thickness direction D1 of the mounting substrate 2. The primary coil 61A of the first balun 6A intersects with the first side 31 and the second side 32 in plan view in the thickness direction D1 of the mounting substrate 2 (e.g., the primary coil 61A of the first balun 6A extends from the first side 31, surrounds (curves around) a corner (a single corner) of the first IC chip 3 that connects between the first and second sides 31 and 32, and extends toward the second side 32).

The radio frequency module 1 according to the first embodiment enables the exclusive areas of a balun (the first balun 6A) and power amplifiers (the first power amplifier 51 and the second power amplifier 52) to be reduced (e.g., a combined area of the first balun 6A, the first power amplifier 51, and the second power amplifier 52 may be reduced).

### (2) Components of Radio Frequency Module

As illustrated in FIG. 1 and FIG. 2, the radio frequency module 1 according to the first embodiment includes the mounting substrate 2, the first IC chip 3, a second IC chip 4, the first balun 6A, a second balun 6B, a third balun 7A, and a fourth balun 7B. As illustrated in FIG. 3, the radio frequency module 1 according to the first embodiment further includes a fifth balun 8A, a sixth balun 8B, multiple external connection terminals 11, multiple (four in an example in FIG. 3) switches 12 to 15, multiple (three in the example in FIG. 3) inductors L1 to L3, and multiple (three in the example in FIG. 3) capacitors C1 to C3.

The components of the radio frequency module 1 according to the first embodiment will now be described with reference to the drawings.

### (2.1) Mounting Substrate

As illustrated in FIG. 1 and FIG. 2, the mounting substrate 2 has a first main surface 21 and a second main surface 22. The first main surface 21 and the second main surface 22 face away from each other. More specifically, the first main surface 21 and the second main surface 22 face away from each other in the thickness direction D1 of the mounting substrate 2. The mounting substrate 2 is used for arranging multiple electronic components and has, for example, a rectangular plate shape. For example, the first main surface 21 and the second main surface 22 have a rectangular shape. The second main surface 22 faces an external substrate provided that the radio frequency module 1 is in or on the external substrate.

The mounting substrate 2 includes multiple dielectric layers and multiple conductive layers. For example, the mounting substrate 2 is a multilayer substrate that includes the multiple dielectric layers and the multiple conductive layers. The multiple dielectric layers and the multiple conductive layers are stacked in the thickness direction D1 of the mounting substrate 2.

The multiple conductive layers include one or multiple conductive portions in a plane perpendicular to the thickness direction D1 of the mounting substrate 2. The multiple conductive layers are formed in patterns that are specified for the respective layers. For example, the material of the conductive layers is copper.

The multiple conductive layers include ground layers. The ground layers have a ground potential (a reference potential) and are provided in, for example, the mounting substrate 2. For example, the radio frequency module 1 may be disposed in or on an external substrate (such as a motherboard), and the ground layers may be connected to the ground of the external substrate with a via conductor that is included in the mounting substrate 2 (e.g., interposed therebetween), so the ground potential (the reference potential) may be maintained.

For example, the mounting substrate 2 is a low temperature co-fired ceramics (LTCC) substrate. The mounting substrate 2 is not limited to the LTCC substrate, and examples thereof include a printed circuit board, a high temperature co-fired ceramics (HTCC) substrate, and a resin multilayer substrate.

### (2.2) First IC Chip

As illustrated in FIG. 1 and FIG. 2, the first IC chip 3 is disposed in or on the mounting substrate 2. The first IC chip 3 includes the first power amplifier 51, the second power amplifier 52 (see FIG. 3), a fourth power amplifier 54, and a fifth power amplifier 55 (see FIG. 3).

The outer periphery 3a of the first IC chip 3 has a polygonal shape in plan view in the thickness direction D1 of the mounting substrate 2. For example, the first IC chip 3 has a rectangular shape. In an example illustrated in FIG. 1, the first IC chip 3 has a rectangular shape (such as a square shape or a rectangular shape).

The outer periphery 3a of the first IC chip 3 has the first side 31, the second side 32, a third side 33, and a fourth side 34. According to the first embodiment, the first side 31 and the second side 32 are adjacent to each other in plan view in the thickness direction D1 of the mounting substrate 2 (e.g., the first side 31 may extend from the second side 32, and may be angled with respect to the second side 32). The third side 33 faces away from the second side 32 in plan view in the thickness direction D1 of the mounting substrate 2. The fourth side 34 faces away from the first side 31 in plan view in the thickness direction D1 of the mounting substrate 2.

The first IC chip 3 is a GaAs IC chip. More specifically, the first IC chip 3 is a GaAs IC chip that includes a GaAs substrate.

### (2.3) Second IC Chip

As illustrated in FIG. 1 and FIG. 2, the second IC chip 4 is disposed in or on the mounting substrate 2. The second IC chip 4 includes a third power amplifier 53 (see FIG. 3) and a sixth power amplifier 56 (see FIG. 3).

The outer periphery of the second IC chip 4 has a polygonal shape in plan view in the thickness direction D1 of the mounting substrate 2. For example, the second IC chip 4 has a rectangular shape. In the example in FIG. 1, the second IC chip 4 has a rectangular shape (such as a square shape or a rectangular shape).

The second IC chip 4 is a Si IC chip. More specifically, the second IC chip 4 is a Si IC chip that includes a silicon-on-insulator (SOI) substrate. The Si IC chip may include a silicon substrate instead of the SOI substrate. The second IC chip 4 is a Si chip, and accordingly, an amplification factor required for the third power amplifier 53 and the sixth power amplifier 56 can be ensured, and costs can be reduced unlike the case where the second IC chip is a GaAs IC chip.

### (2.4) Power Amplifier

### (2.4.1) First Power Amplifier, Second Power Amplifier, and Third Power Amplifier

The first power amplifier 51 and the second power amplifier 52 illustrated in FIG. 3 amplify a transmission signal (a first transmission signal) at a first frequency. The first transmission signal that is amplified by the first power amplifier 51 and the second power amplifier 52 is outputted to an antenna terminal 171 via the first balun 6A, the switch 12, and a filter.

The first power amplifier 51 and the second power amplifier 52 are provided between the second balun 6B and the first balun 6A. The first power amplifier 51 includes an input terminal 511 and the output terminal 512. The input terminal 511 of the first power amplifier 51 is connected to a secondary coil 62B of the second balun 6B. The output terminal 512 of the first power amplifier 51 is connected to the primary coil 61A of the first balun 6A. The second power amplifier 52 includes an input terminal 521 and the output terminal 522. The input terminal 521 of the second power amplifier 52 is connected to the secondary coil 62B of the second balun 6B. The output terminal 522 of the second power amplifier 52 is connected to the primary coil 61A of the first balun 6A.

The third power amplifier 53 illustrated in FIG. 3 amplifies the transmission signal (the first transmission signal) at the first frequency. The first transmission signal that is amplified by the third power amplifier 53 is outputted to the first power amplifier 51 and the second power amplifier 52 via the second balun 6B.

The third power amplifier 53 is connected to the input terminal 511 of the first power amplifier 51 and the input terminal 521 of the second power amplifier 52. More specifically, the third power amplifier 53 is connected to the input terminal 511 of the first power amplifier 51 and the input terminal 521 of the second power amplifier 52 with the second balun 6B interposed therebetween. The third power amplifier 53 is provided between signal input terminals 161 and 162 and the second balun 6B. The third power amplifier 53 includes an input terminal 531 and an output terminal 532. The input terminal 531 of the third power amplifier 53 is connected to the signal input terminals 161 and 162 with the switch 14 interposed therebetween. The third power amplifier 53 is connected to an external circuit (such as a signal processing circuit 92) with the signal input terminals 161 and 162 interposed therebetween. The output terminal 532 of the third power amplifier 53 is connected to a primary coil 61B of the second balun 6B.

### (2.4.2) Fourth Power Amplifier, Fifth Power Amplifier, and Sixth Power Amplifier

The fourth power amplifier 54 and the fifth power amplifier 55 illustrated in FIG. 3 amplify a transmission signal (a second transmission signal) at a second frequency. The second frequency is higher than the first frequency. The second transmission signal that is amplified by the fourth power amplifier 54 and the fifth power amplifier 55 is outputted to the antenna terminal 171 via the third balun 7A, the switch 12, and a filter.

The fourth power amplifier 54 and the fifth power amplifier 55 are provided between the fourth balun 7B and the third balun 7A. The fourth power amplifier 54 includes an input terminal 541 and an output terminal 542. The input terminal 541 of the fourth power amplifier 54 is connected to a secondary coil 72B of the fourth balun 7B. The output terminal 542 of the fourth power amplifier 54 is connected to a primary coil 71A of the third balun 7A. The fifth power amplifier 55 includes an input terminal 551 and an output terminal 552. The input terminal 551 of the fifth power amplifier 55 is connected to the secondary coil 72B of the fourth balun 7B. The output terminal 552 of the fifth power amplifier 55 is connected to the primary coil 71A of the third balun 7A.

The sixth power amplifier 56 illustrated in FIG. 3 amplifies the transmission signal (the second transmission signal) at the second frequency. The second transmission signal that is amplified by the sixth power amplifier 56 is outputted to the fourth power amplifier 54 and the fifth power amplifier 55 via the fourth balun 7B.

The sixth power amplifier 56 is connected to the input terminal 541 of the fourth power amplifier 54 and the input terminal 551 of the fifth power amplifier 55. More specifically, the sixth power amplifier 56 is connected to the input terminal 541 of the fourth power amplifier 54 and the input terminal 551 of the fifth power amplifier 55 with the fourth balun 7B interposed therebetween. The sixth power amplifier 56 is provided between a signal input terminal 163 and the fourth balun 7B. The sixth power amplifier 56 includes an input terminal 561 and an output terminal 562. The input terminal 561 of the sixth power amplifier 56 is connected to the signal input terminal 163. The sixth power amplifier 56 is connected to an external circuit (such as the signal processing circuit 92) with the signal input terminal 163 interposed therebetween. The output terminal 562 of the sixth power amplifier 56 is connected to a primary coil 71B of the fourth balun 7B.

### (2.4.3) Seventh Power Amplifier, Eighth Power Amplifier, and Ninth Power Amplifier

A seventh power amplifier 57 and an eighth power amplifier 58 illustrated in FIG. 3 amplify a transmission signal (a third transmission signal) at a third frequency. The third transmission signal that is amplified by the seventh power amplifier 57 and the eighth power amplifier 58 is outputted to an antenna terminal 172 via the fifth balun 8A, the switch 13, and a filter.

The seventh power amplifier 57 and the eighth power amplifier 58 are provided between the sixth balun 8B and the fifth balun 8A. The seventh power amplifier 57 includes an input terminal 571 and an output terminal 572. The input terminal 571 of the seventh power amplifier 57 is connected to a secondary coil 82B of the sixth balun 8B. The output terminal 572 of the seventh power amplifier 57 is connected to a primary coil 81A of the fifth balun 8A. The eighth power amplifier 58 includes an input terminal 581 and an output terminal 582. The input terminal 581 of the eighth power amplifier 58 is connected to the secondary coil 82B of the sixth balun 8B. The output terminal 582 of the eighth power amplifier 58 is connected to the primary coil 81A of the fifth balun 8A.

A ninth power amplifier 59 illustrated in FIG. 3 amplifies the transmission signal (the third transmission signal) at the third frequency. The third transmission signal that is amplified by the ninth power amplifier 59 is outputted to the seventh power amplifier 57 and the eighth power amplifier 58 via the sixth balun 8B.

The ninth power amplifier 59 is connected to the input terminal 571 of the seventh power amplifier 57 and the input terminal 581 of the eighth power amplifier 58. More specifically, the ninth power amplifier 59 is connected to the input terminal 571 of the seventh power amplifier 57 and the input terminal 581 of the eighth power amplifier 58 with the sixth balun 8B interposed therebetween. The ninth power amplifier 59 is provided between signal input terminals 164 and 165 and the sixth balun 8B. The ninth power amplifier 59 includes an input terminal 591 and an output terminal 592. The input terminal 591 of the ninth power amplifier 59 is connected to the signal input terminals 164 and 165 with the switch 15 interposed therebetween. The ninth power amplifier 59 is connected to an external circuit (such as the signal processing circuit 92) with the signal input terminals 164 and 165 interposed therebetween. The output terminal 592 of the ninth power amplifier 59 is connected to a primary coil 81B of the sixth balun 8B.

### (2.5) First Balun

As illustrated in FIG. 1 and FIG. 2, the first balun 6A is disposed in or on the mounting substrate 2. As illustrated in FIG. 1 to FIG. 3, the first balun 6A includes the primary coil 61A and a secondary coil 62A.

As illustrated in FIG. 1 and FIG. 2, the primary coil 61A is disposed on the first main surface 21 of the mounting substrate 2. In other words, the primary coil 61A is disposed on the main surface of the mounting substrate 2 on which the first IC chip 3 and the second IC chip 4 are disposed (e.g., the primary coil 61A, the first IC chip 3, and the second IC chip 4 may be external with respect to the mounting substrate 2, and may have bottom surfaces thereof coplanar with each other and facing the mounting substrate 2).

As illustrated in FIG. 3, the primary coil 61A is connected between the output terminal 512 of the first power amplifier 51 and the output terminal 522 of the second power amplifier 52. More specifically, as illustrated in FIG. 1 to FIG. 3, of both ends (a first end and a second end) of the primary coil 61A, the first end of the primary coil 61A is connected to the output terminal 512 of the first power amplifier 51, and the second end of the primary coil 61A is connected to the output terminal 522 of the second power amplifier 52. The second end of the primary coil 61A is connected to a power terminal 181.

As illustrated in FIG. 2, the secondary coil 62A is disposed in the mounting substrate 2 (e.g., the secondary coil 62A may be internal with respect to the mounting substrate 2). More specifically, the secondary coil 62A is disposed between the first main surface 21 and the second main surface 22 of the mounting substrate 2 in the thickness direction D1 of the mounting substrate 2 (e.g., the primary coil 61A and the secondary coil 62A may be at different height levels relative to the first main surface 21). The secondary coil 62A includes multilayered wiring conductors and a via conductor. The multilayered wiring conductors are arranged in the thickness direction D1 of the mounting substrate 2. The via conductor connects the multilayered wiring conductors.

As illustrated in FIG. 3, the secondary coil 62A is connected to the switch 12. More specifically, of both ends (a first end and a second end) of the secondary coil 62A, the first end of the secondary coil 62A is connected to the switch 12, and the second end of the secondary coil 62A is connected to a ground terminal and has the ground potential.

### (2.6) Second Balun

As illustrated in FIG. 1 and FIG. 2, the second balun 6B is disposed in or on the mounting substrate 2. As illustrated in FIG. 1 to FIG. 3, the second balun 6B includes the primary coil 61B and the secondary coil 62B.

As illustrated in FIG. 2, the primary coil 61B is disposed in the mounting substrate 2. More specifically, the primary coil 61B is disposed between the first main surface 21 and the second main surface 22 of the mounting substrate 2 in the thickness direction D1 of the mounting substrate 2. The primary coil 61B includes multilayered wiring conductors and a via conductor. The multilayered wiring conductors are arranged in the thickness direction D1 of the mounting substrate 2. The via conductor connects the multilayered wiring conductors.

As illustrated in FIG. 3, the primary coil 61B is connected to the output terminal 532 of the third power amplifier 53. More specifically, as illustrated in FIG. 2 and FIG. 3, of both ends (a first end and a second end) of the primary coil 61B, the first end of the primary coil 61B is connected to the output terminal 532 of the third power amplifier 53, and the second end of the primary coil 61B is connected to a power terminal 182.

As illustrated in FIG. 1 and FIG. 2, the secondary coil 62B is disposed on the first main surface 21 of the mounting substrate 2. In other words, the secondary coil 62B is disposed on the main surface of the mounting substrate 2 on which the first IC chip 3 and the second IC chip 4 are disposed.

As illustrated in FIG. 3, the secondary coil 62B is connected between the input terminal 511 of the first power amplifier 51 and the input terminal 521 of the second power amplifier 52. More specifically, as illustrated in FIG. 1 to FIG. 3, of both ends (a first end and a second end) of the secondary coil 62B, the first end of the secondary coil 62B is connected to the input terminal 511 of the first power amplifier 51, and the second end of the secondary coil 62B is connected to the input terminal 521 of the second power amplifier 52.

### (2.7) Third Balun

As illustrated in FIG. 1 and FIG. 2, the third balun 7A is disposed in or on the mounting substrate 2. As illustrated in FIG. 1 to FIG. 3, the third balun 7A includes the primary coil 71A and a secondary coil 72A.

As illustrated in FIG. 1 and FIG. 2, the primary coil 71A is disposed on the first main surface 21 of the mounting substrate 2. In other words, the primary coil 71A is disposed on the main surface of the mounting substrate 2 on which the first IC chip 3 and the second IC chip 4 are disposed.

As illustrated in FIG. 3, the primary coil 71A is connected between the output terminal 542 of the fourth power amplifier 54 and the output terminal 552 of the fifth power amplifier 55. More specifically, as illustrated in FIG. 1 to FIG. 3, of both ends (a first end and a second end) of the primary coil 71A, the first end of the primary coil 71A is connected to the output terminal 542 of the fourth power amplifier 54, and the second end of the primary coil 71A is connected to the output terminal 552 of the fifth power amplifier 55. The second end of the primary coil 71A is connected to a power terminal 183.

As illustrated in FIG. 2, the secondary coil 72A is disposed in the mounting substrate 2. More specifically, the secondary coil 72A is disposed between the first main surface 21 and the second main surface 22 of the mounting substrate 2 in the thickness direction D1 of the mounting substrate 2. The secondary coil 72A includes multilayered wiring conductors and a via conductor. The multilayered wiring conductors are arranged in the thickness direction D1 of the mounting substrate 2. The via conductor connects the multilayered wiring conductors.

As illustrated in FIG. 3, the secondary coil 72A is connected to the switch 12. More specifically, of both ends (a first end and a second end) of the secondary coil 72A, the first end of the secondary coil 72A is connected to the switch 12, and the second end of the secondary coil 72A is connected to the ground terminal and has the ground potential.

### (2.8) Fourth Balun

As illustrated in FIG. 1 and FIG. 2, the fourth balun 7B is disposed in or on the mounting substrate 2. As illustrated in FIG. 1 to FIG. 3, the fourth balun 7B includes the primary coil 71B and the secondary coil 72B.

As illustrated in FIG. 2, the primary coil 71B is disposed in the mounting substrate 2. More specifically, the primary coil 71B is disposed between the first main surface 21 and the second main surface 22 of the mounting substrate 2 in the thickness direction D1 of the mounting substrate 2. The primary coil 71B includes multilayered wiring conductors and a via conductor. The multilayered wiring conductors are arranged in the thickness direction D1 of the mounting substrate 2. The via conductor connects the multilayered wiring conductors.

As illustrated in FIG. 3, the primary coil 71B is connected to the output terminal 562 of the sixth power amplifier 56. More specifically, as illustrated in FIG. 2 and FIG. 3, of both ends (a first end and a second end) of the primary coil 71B, the first end of the primary coil 71B is connected to the output terminal 562 of the sixth power amplifier 56, and the second end of the primary coil 71B is connected to a power terminal 184.

As illustrated in FIG. 1 and FIG. 2, the secondary coil 72B is disposed on the first main surface 21 of the mounting substrate 2. In other words, the secondary coil 72B is disposed on the main surface of the mounting substrate 2 on which the first IC chip 3 and the second IC chip 4 are disposed.

As illustrated in FIG. 3, the secondary coil 72B is connected between the input terminal 541 of the fourth power amplifier 54 and the input terminal 551 of the fifth power amplifier 55. More specifically, as illustrated in FIG. 1 to FIG. 3, of both ends (a first end and a second end) of the secondary coil 72B, the first end of the secondary coil 72B is connected to the input terminal 541 of the fourth power amplifier 54, and the second end of the secondary coil 72B is connected to the input terminal 551 of the fifth power amplifier 55.

### (2.9) Fifth Balun

The fifth balun 8A is disposed in or on the mounting substrate 2 (see FIG. 1). As illustrated in FIG. 3, the fifth balun 8A includes the primary coil 81A and a secondary coil 82A.

The primary coil 81A is disposed on the first main surface 21 (see FIG. 1) of the mounting substrate 2. In other words, the primary coil 81A is disposed on the main surface of the mounting substrate 2 on which the first IC chip 3 and the second IC chip 4 are disposed.

As illustrated in FIG. 3, the primary coil 81A is connected between the output terminal 572 of the seventh power amplifier 57 and the output terminal 582 of the eighth power amplifier 58. More specifically, as illustrated in FIG. 3, of both ends (a first end and a second end) of the primary coil 81A, the first end of the primary coil 81A is connected to the output terminal 572 of the seventh power amplifier 57, and the second end of the primary coil 81A is connected to the output terminal 582 of the eighth power amplifier 58. The second end of the primary coil 81A is connected to a power terminal 185.

The secondary coil 82A is disposed in the mounting substrate 2 (see FIG. 1). More specifically, the secondary coil 82A is disposed between the first main surface 21 and the second main surface 22 of the mounting substrate 2 in the thickness direction D1 of the mounting substrate 2. The secondary coil 82A includes multilayered wiring conductors and a via conductor. The multilayered wiring conductors are arranged in the thickness direction D1 of the mounting substrate 2. The via conductor connects the multilayered wiring conductors.

As illustrated in FIG. 3, the secondary coil 82A is connected to the switch 13. More specifically, of both ends (a first end and a second end) of the secondary coil 82A, the first end of the secondary coil 82A is connected to the switch 13, and the second end of the secondary coil 82A is connected to the ground terminal and has the ground potential.

### (2.10) Sixth Balun

The sixth balun 8B is disposed in or on the mounting substrate 2 (see FIG. 1). As illustrated in FIG. 3, the sixth balun 8B includes the primary coil 81B and the secondary coil 82B.

The primary coil 81B is disposed in the mounting substrate 2. More specifically, the primary coil 81B is disposed between the first main surface 21 and the second main surface 22 of the mounting substrate 2 in the thickness direction D1 of the mounting substrate 2. The primary coil 81B includes multilayered wiring conductors and a via conductor. The multilayered wiring conductors are arranged in the thickness direction D1 of the mounting substrate 2. The via conductor connects the multilayered wiring conductors.

As illustrated in FIG. 3, the primary coil 81B is connected to the output terminal 592 of the ninth power amplifier 59. More specifically, as illustrated in FIG. 3, of both ends (a first end and a second end) of the primary coil 81B, the first end of the primary coil 81B is connected to the output terminal 592 of the ninth power amplifier 59, and the second end of the primary coil 81B is connected to a power terminal 186.

The secondary coil 82B is disposed on the first main surface 21 (see FIG. 1) of the mounting substrate 2. In other words, the secondary coil 82B is disposed on the main surface of the mounting substrate 2 on which the first IC chip 3 and the second IC chip 4 are disposed.

As illustrated in FIG. 3, the secondary coil 82B is connected between the input terminal 571 of the seventh power amplifier 57 and the input terminal 581 of the eighth power amplifier 58. More specifically, as illustrated in FIG. 3, of both ends (a first end and a second end) of the secondary coil 82B, the first end of the secondary coil 82B is connected to the input terminal 571 of the seventh power amplifier 57, and the second end of the secondary coil 82B is connected to the input terminal 581 of the eighth power amplifier 58.

### (2.11) External Connection Terminal

As illustrated in FIG. 3, the multiple external connection terminals 11 include the multiple (five in the example in FIG. 3) signal input terminals 161 to 165, the multiple (two in the example in FIG. 3) antenna terminals 171 and 172, and the multiple (six in the example in FIG. 3) power terminals 181 to 186.

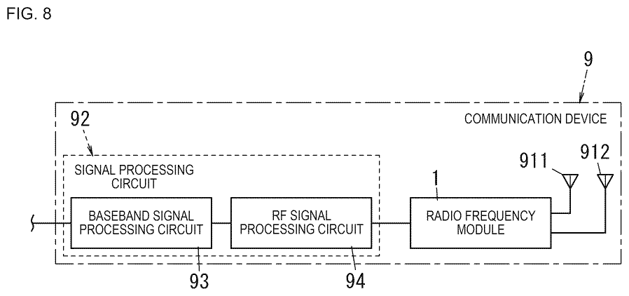

The multiple signal input terminals 161 to 165 are connected to the signal processing circuit 92 (see FIG. 8). Radio frequency signals (transmission signals) from the signal processing circuit 92 are inputted into the radio frequency module 1 via the multiple signal input terminals 161 to 165.

The transmission signal (the first transmission signal) at the first frequency is inputted via the signal input terminals 161 and 162. The first transmission signal of a fifth generation mobile communication (5G) standard, for example, is inputted via the signal input terminal 161. The first transmission signal of a second generation mobile communication (2G) standard, for example, is inputted via the signal input terminal 162. The transmission signal (the second transmission signal) at the second frequency is inputted via the signal input terminal 163. The second transmission signal of the 5G standard, for example, is inputted via the signal input terminal 163. The transmission signal (the third transmission signal) at the third frequency is inputted via the signal input terminals 164 and 165. The third transmission signal of the 5G standard, for example, is inputted via the signal input terminal 164. The third transmission signal of the 2G standard, for example, is inputted via the signal input terminal 165.

The multiple antenna terminals 171 and 172 have a one-to-one relationship with multiple antennas 911 and 912 (see FIG. 8). The multiple antenna terminals 171 and 172 are connected to the respective antennas 911 and 912. More specifically, the antenna terminal 171 is connected to the antenna 911. The antenna terminal 172 is connected to the antenna 912.

The multiple power terminals 181 to 186 have a one-to-one relationship with the multiple baluns (the first balun 6A, the second balun 6B, the third balun 7A, the fourth balun 7B, the fifth balun 8A, and the sixth balun 8B). The multiple power terminals 181 to 186 are connected to the respective baluns. The power terminal 181 is connected to the primary coil 61A of the first balun 6A. More specifically, the power terminal 182 is connected to the primary coil 61B of the second balun 6B. The power terminal 183 is connected to the primary coil 71A of the third balun 7A. The power terminal 184 is connected to the primary coil 71B of the fourth balun 7B. The power terminal 185 is connected to the primary coil 81A of the fifth balun 8A. The power terminal 186 is connected to the primary coil 81B of the sixth balun 8B.

### (2.12) Switch

As illustrated in FIG. 3, the switch 12 switches paths for connection to the filter that is connected to the antenna terminal 171. For example, the switch 12 is a switch IC.

The switch 12 includes a common terminal 121 and multiple (two in the example in FIG. 3) selection terminals 122 and 123. The common terminal 121 is connected to the filter that is connected to the antenna terminal 171. The selection terminal 122 is connected to the secondary coil 62A of the first balun 6A. The selection terminal 123 is connected to the secondary coil 72A of the third balun 7A. For example, the switch 12 is controlled by the signal processing circuit 92 (see FIG. 8). The switch 12 switches a connection state between the common terminal 121 and the multiple selection terminals 122 and 123 in accordance with a control signal from a RF signal processing circuit 94 (see FIG. 8) of the signal processing circuit 92.

As illustrated in FIG. 3, the switch 13 switches paths for connection to a filter that is connected to the antenna terminal 172. For example, the switch 13 is a switch IC.

The switch 13 includes a common terminal 131 and multiple (two in the example in FIG. 3) selection terminals 132 and 133. The common terminal 131 is connected to the filter that is connected to the antenna terminal 172. The selection terminal 132 is connected to the secondary coil 82A of the fifth balun 8A. For example, the switch 13 is controlled by the signal processing circuit 92 (see FIG. 8). The switch 13 switches a connection state between the common terminal 131 and the multiple selection terminals 132 and 133 in accordance with a control signal from the RF signal processing circuit 94 (see FIG. 8) of the signal processing circuit 92.

As illustrated in FIG. 3, the switch 14 switches paths for connection to the third power amplifier 53. For example, the switch 14 is a switch IC.

The switch 14 includes a common terminal 141 and multiple (two in the example in FIG. 3) selection terminals 142 and 143. The common terminal 141 is connected to the third power amplifier 53. The selection terminal 142 is connected to the signal input terminal 161. The selection terminal 143 is connected to the signal input terminal 162. For example, the switch 14 is controlled by the signal processing circuit 92 (see FIG. 8). The switch 14 switches a connection state between the common terminal 141 and the multiple selection terminals 142 and 143 in accordance with a control signal from the RF signal processing circuit 94 (see FIG. 8) of the signal processing circuit 92.

As illustrated in FIG. 3, the switch 15 switches paths for connection to the ninth power amplifier 59. For example, the switch 15 is a switch IC.

The switch 15 includes a common terminal 151 and multiple (two in the example in FIG. 3) selection terminals 152 and 153. The common terminal 151 is connected to the ninth power amplifier 59. The selection terminal 152 is connected to the signal input terminal 164. The selection terminal 153 is connected to the signal input terminal 165. For example, the switch 15 is controlled by the signal processing circuit 92 (see FIG. 8). The switch 15 switches a connection state between the common terminal 151 and the multiple selection terminals 152 and 153 in accordance with a control signal from the RF signal processing circuit 94 (see FIG. 8) of the signal processing circuit 92.

### (2.13) Inductor and Capacitor

As illustrated in FIG. 3, the inductor L1 and the capacitor C1 are connected between the secondary coil 62B of the first balun 6A and the ground. The inductor L1 and the capacitor C1 are connected in series.

As illustrated in FIG. 3, the inductor L2 and the capacitor C2 are connected between the secondary coil 72B of the third balun 7A and the ground. The inductor L2 and the capacitor C2 are connected in series.

As illustrated in FIG. 3, the inductor L3 and the capacitor C3 are connected between the secondary coil 82B of the fifth balun 8A and the ground. The inductor L3 and the capacitor C3 are connected in series.

### (3) Positional Relationship

As for the outer periphery 3a of the first IC chip 3, as illustrated in FIG. 1, the first side 31 and the second side 32 differ from each other.

According to the first embodiment, the first side 31 and the second side 32 of the outer periphery 3a of the first IC chip 3 are adjacent to each other in plan view in the thickness direction D1 of the mounting substrate 2.

As illustrated in FIG. 1, the output terminal 512 of the first power amplifier 51 is disposed along the first side 31 of the outer periphery 3a of the first IC chip 3 in plan view in the thickness direction D1 of the mounting substrate 2. More specifically, the output terminal 512 of the first power amplifier 51 is disposed on the main surface of the first IC chip 3 that faces the mounting substrate 2. The output terminal 512 of the first power amplifier 51 is disposed nearer than the second side 32, the third side 33, and the fourth side 34 to the first side 31 of the outer periphery 3a of the first IC chip 3 in plan view in the thickness direction D1 of the mounting substrate 2. For example, a distance between the output terminal 512 and the first side 31 is smaller than a distance between the output terminal 512 and each of the second to fourth sides 32 to 34, while the distance is measured from the output terminal 512 along a direction normal to the corresponding side. For example, a distance between the output terminal 512 of the first power amplifier 51 to the first side 31 may be different from (e.g., smaller than) a distance between the output terminal 522 of the second power amplifier 52 to the first side 31.

In the present specification, the phrase “the output terminal 512 of the first power amplifier 51 is disposed along the first side 31 of the outer periphery 3a of the first IC chip 3 in plan view in the thickness direction D1 of the mounting substrate 2″ refers to the phrase ”the output terminal 512 of the first power amplifier 51 is disposed nearer than the second side 32, the third side 33, and the fourth side 34 to the first side 31 of the outer periphery 3a of the first IC chip 3 in plan view in the thickness direction D1 of the mounting substrate 2″.

As illustrated in FIG. 1, the output terminal 522 of the second power amplifier 52 is disposed along the second side 32 of the outer periphery 3a of the first IC chip 3 in plan view in the thickness direction D1 of the mounting substrate 2. More specifically, the output terminal 522 of the second power amplifier 52 is disposed on the main surface of the first IC chip 3 that faces the mounting substrate 2. The output terminal 522 of the second power amplifier 52 is disposed nearer than the first side 31, the third side 33, and the fourth side 34 to the second side 32 of the outer periphery 3a of the first IC chip 3 in plan view in the thickness direction D1 of the mounting substrate 2. For example, a distance between the output terminal 522 and the second side 32 is smaller than a distance between the output terminal 522 and each of the first, third, and fourth sides 31, 33, and 34, while the distance is measured from the output terminal 522 along a direction normal to the corresponding side. For example, a distance between the output terminal 522 of the second power amplifier 52 to the second side 32 is different from (e.g., smaller than) a distance between the output terminal 512 of the first power amplifier 51 to the second side 32.

In the present specification, the phrase “the output terminal 522 of the second power amplifier 52 is disposed along the second side 32 of the outer periphery 3a of the first IC chip 3 in plan view in the thickness direction D1 of the mounting substrate 2″ refers to the phrase ”the output terminal 522 of the second power amplifier 52 is disposed nearer than the first side 31, the third side 33, and the fourth side 34 to the second side 32 of the outer periphery 3a of the first IC chip 3 in plan view in the thickness direction D1 of the mounting substrate 2″.

As illustrated in FIG. 1, the primary coil 61A of the first balun 6A intersects with the first side 31 and the second side 32 of the outer periphery 3a of the first IC chip 3 in plan view in the thickness direction D1 of the mounting substrate 2. More specifically, the first side 31 of the outer periphery 3a of the first IC chip 3 extends in a first direction D21 in plan view in the thickness direction D1 of the mounting substrate 2, but the first end of the primary coil 61A extends in a second direction D22. Accordingly, the first end of the primary coil 61A intersects with the first side 31 of the outer periphery 3a of the first IC chip 3 in plan view in the thickness direction D1 of the mounting substrate 2. The second side 32 of the outer periphery 3a of the first IC chip 3 extends in the second direction D22 in plan view in the thickness direction D1 of the mounting substrate 2, but the second end of the primary coil 61A extends in the first direction D21. Accordingly, the second end of the primary coil 61A intersects with the second side 32 of the outer periphery 3a of the first IC chip 3 in plan view in the thickness direction D1 of the mounting substrate 2. The first direction D21 is perpendicular to the thickness direction D1 of the mounting substrate 2. The second direction D22 is perpendicular to the thickness direction D1 of the mounting substrate 2 and the first direction D21.

As illustrated in FIG. 2, the secondary coil 62A of the first balun 6A intersects with the first side 31 and the second side 32 of the outer periphery 3a of the first IC chip 3 in plan view in the thickness direction D1 of the mounting substrate 2. More specifically, a portion of the secondary coil 62A of the first balun 6A that intersects with the first side 31 extends in the second direction D22, and the secondary coil 62A of the first balun 6A intersects with the first side 31 at the portion described above so as to be perpendicular thereto. A portion of the secondary coil 62A of the first balun 6A that intersects with the second side 32 extends in the first direction D21, and the secondary coil 62A of the first balun 6A intersects with the second side 32 at the portion described above so as to be perpendicular thereto.

The secondary coil 62A of the first balun 6A overlaps the primary coil 61A of the first balun 6A in plan view in the thickness direction D1 of the mounting substrate 2. In the present specification, the phrase “the secondary coil 62A of the first balun 6A overlaps the primary coil 61A of the first balun 6A in plan view in the thickness direction D1 of the mounting substrate 2” refers to a configuration that at least a portion of the secondary coil 62A of the first balun 6A overlaps at least a portion of the primary coil 61A of the first balun 6A in plan view in the thickness direction D1 of the mounting substrate 2. Specifically, the case of the phrase “the secondary coil 62A of the first balun 6A overlaps the primary coil 61A of the first balun 6A in plan view in the thickness direction D1 of the mounting substrate 2” includes the case where a portion of the secondary coil 62A of the first balun 6A overlaps a portion of the primary coil 61A of the first balun 6A in plan view in the thickness direction D1 of the mounting substrate 2, the case where a portion of the secondary coil 62A of the first balun 6A overlaps the whole of the primary coil 61A of the first balun 6A in plan view in the thickness direction D1 of the mounting substrate 2, the case where the whole of the secondary coil 62A of the first balun 6A overlaps a portion of the primary coil 61A of the first balun 6A in plan view in the thickness direction D1 of the mounting substrate 2, and the case where the whole of the secondary coil 62A of the first balun 6A overlaps the whole of the primary coil 61A of the first balun 6A in plan view in the thickness direction D1 of the mounting substrate 2.

According to the first embodiment, the third side 33 of the outer periphery 3a of the first IC chip 3 faces away from the second side 32 in plan view in the thickness direction D1 of the mounting substrate 2.

As illustrated in FIG. 1, the input terminal 511 of the first power amplifier 51 is disposed along the first side 31 of the outer periphery 3a of the first IC chip 3 in plan view in the thickness direction D1 of the mounting substrate 2. More specifically, the input terminal 511 of the first power amplifier 51 is disposed on the main surface of the first IC chip 3 that faces the mounting substrate 2. The input terminal 511 of the first power amplifier 51 is disposed nearer than the second side 32, the third side 33, and the fourth side 34 to the first side 31 of the outer periphery 3a of the first IC chip 3 in plan view in the thickness direction D1 of the mounting substrate 2.

In the present specification, the phrase “the input terminal 511 of the first power amplifier 51 is disposed along the first side 31 of the outer periphery 3a of the first IC chip 3 in plan view in the thickness direction D1 of the mounting substrate 2″ refers to the phrase ”the input terminal 511 of the first power amplifier 51 is disposed nearer than the second side 32, the third side 33, and the fourth side 34 to the first side 31 of the outer periphery 3a of the first IC chip 3 in plan view in the thickness direction D1 of the mounting substrate 2″.

As illustrated in FIG. 1, the input terminal 521 of the second power amplifier 52 is disposed along the third side 33 of the outer periphery 3a of the first IC chip 3 in plan view in the thickness direction D1 of the mounting substrate 2. More specifically, the input terminal 521 of the second power amplifier 52 is disposed on the main surface of the first IC chip 3 that faces the mounting substrate 2. The input terminal 521 of the second power amplifier 52 is disposed nearer than the first side 31, the second side 32, and the fourth side 34 to the third side 33 of the outer periphery 3a of the first IC chip 3 in plan view in the thickness direction D1 of the mounting substrate 2.

As illustrated in FIG. 1, the secondary coil 62B of the second balun 6B intersects with the first side 31 and the third side 33 of the outer periphery 3a of the first IC chip 3 in plan view in the thickness direction D1 of the mounting substrate 2. More specifically, the first side 31 of the outer periphery 3a of the first IC chip 3 extends in the first direction D21 in plan view in the thickness direction D1 of the mounting substrate 2, but the first end of the secondary coil 62B extends in the second direction D22. Accordingly, the first end of the secondary coil 62B intersects with the first side 31 of the outer periphery 3a of the first IC chip 3 in plan view in the thickness direction D1 of the mounting substrate 2. The third side 33 of the outer periphery 3a of the first IC chip 3 extends in the second direction D22 in plan view in the thickness direction D1 of the mounting substrate 2, but the second end of the secondary coil 62B extends in the first direction D21. Accordingly, the second end of the secondary coil 62B intersects with the third side 33 of the outer periphery 3a of the first IC chip 3 in plan view in the thickness direction D1 of the mounting substrate 2.

As illustrated in FIG. 1, the output terminal 542 of the fourth power amplifier 54 is disposed along the fourth side 34 of the outer periphery 3a of the first IC chip 3 in plan view in the thickness direction D1 of the mounting substrate 2. More specifically, the output terminal 542 of the fourth power amplifier 54 is disposed on the main surface of the first IC chip 3 that faces the mounting substrate 2. The output terminal 542 of the fourth power amplifier 54 is disposed nearer than the first side 31, the second side 32, and the third side 33 to the fourth side 34 of the outer periphery 3a of the first IC chip 3 in plan view in the thickness direction D1 of the mounting substrate 2.

In the present specification, the phrase “the output terminal 542 of the fourth power amplifier 54 is disposed along the fourth side 34 of the outer periphery 3a of the first IC chip 3 in plan view in the thickness direction D1 of the mounting substrate 2” refers to the phrase “the output terminal 542 of the fourth power amplifier 54 is disposed nearer than the first side 31, the second side 32, and the third side 33 to the fourth side 34 of the outer periphery 3a of the first IC chip 3 in plan view in the thickness direction D1 of the mounting substrate 2”.

As illustrated in FIG. 1, the output terminal 552 of the fifth power amplifier 55 is disposed along the second side 32 of the outer periphery 3a of the first IC chip 3 in plan view in the thickness direction D1 of the mounting substrate 2. More specifically, the output terminal 552 of the fifth power amplifier 55 is disposed on the main surface of the first IC chip 3 that faces the mounting substrate 2. The output terminal 552 of the fifth power amplifier 55 is disposed nearer than the first side 31, the third side 33, and the fourth side 34 to the second side 32 of the outer periphery 3a of the first IC chip 3 in plan view in the thickness direction D1 of the mounting substrate 2.

In the present specification, the phrase “the output terminal 552 of the fifth power amplifier 55 is disposed along the second side 32 of the outer periphery 3a of the first IC chip 3 in plan view in the thickness direction D1 of the mounting substrate 2” refers to the phrase “the output terminal 552 of the fifth power amplifier 55 is disposed nearer than the first side 31, the third side 33, and the fourth side 34 to the second side 32 of the outer periphery 3a of the first IC chip 3 in plan view in the thickness direction D1 of the mounting substrate 2”.

As illustrated in FIG. 1, the primary coil 71A of the third balun 7A intersects with the fourth side 34 and the second side 32 of the outer periphery 3a of the first IC chip 3 in plan view in the thickness direction D1 of the mounting substrate 2. More specifically, the fourth side 34 of the outer periphery 3a of the first IC chip 3 extends in the first direction D21 in plan view in the thickness direction D1 of the mounting substrate 2, but the first end of the primary coil 71A extends in the second direction D22. Accordingly, the first end of the primary coil 71A intersects with the fourth side 34 of the outer periphery 3a of the first IC chip 3 in plan view in the thickness direction D1 of the mounting substrate 2. The second side 32 of the outer periphery 3a of the first IC chip 3 extends in the second direction D22 in plan view in the thickness direction D1 of the mounting substrate 2, but the second end of the primary coil 71A extends in the first direction D21. Accordingly, the second end of the primary coil 71A intersects with the second side 32 of the outer periphery 3a of the first IC chip 3 in plan view in the thickness direction D1 of the mounting substrate 2.

As illustrated in FIG. 2, the secondary coil 72A of the third balun 7A intersects with the fourth side 34 and the second side 32 of the outer periphery 3a of the first IC chip 3 in plan view in the thickness direction D1 of the mounting substrate 2. More specifically, a portion of the secondary coil 72A of the third balun 7A that intersects with the fourth side 34 extends in the second direction D22, and the secondary coil 72A of the third balun 7A intersects with the fourth side 34 at the portion described above so as to be perpendicular thereto. A portion of the secondary coil 72A of the third balun 7A that intersects with the second side 32 extends in the first direction D21, and the secondary coil 72A of the third balun 7A intersects with the second side 32 at the portion described above so as to be perpendicular thereto.

The secondary coil 72A of the third balun 7A overlaps the primary coil 71A of the third balun 7A in plan view in the thickness direction D1 of the mounting substrate 2. In the present specification, the phrase “the secondary coil 72A of the third balun 7A overlaps the primary coil 71A of the third balun 7A in plan view in the thickness direction D1 of the mounting substrate 2” refers to the phrase that at least a portion of the secondary coil 72A of the third balun 7A overlaps at least a portion of the primary coil 71A of the third balun 7A in plan view in the thickness direction D1 of the mounting substrate 2. Specifically, the case of the phrase “the secondary coil 72A of the third balun 7A overlaps the primary coil 71A of the third balun 7A in plan view in the thickness direction D1 of the mounting substrate 2” includes the case where a portion of the secondary coil 72A of the third balun 7A overlaps a portion of the primary coil 71A of the third balun 7A in plan view in the thickness direction D1 of the mounting substrate 2, the case where a portion of the secondary coil 72A of the third balun 7A overlaps the whole of the primary coil 71A of the third balun 7A in plan view in the thickness direction D1 of the mounting substrate 2, the case where the whole of the secondary coil 72A of the third balun 7A overlaps a portion of the primary coil 71A of the third balun 7A in plan view in the thickness direction D1 of the mounting substrate 2, and the case where the whole of the secondary coil 72A of the third balun 7A overlaps the whole of the primary coil 71A of the third balun 7A in plan view in the thickness direction D1 of the mounting substrate 2.

As illustrated in FIG. 1, the input terminal 541 of the fourth power amplifier 54 is disposed along the fourth side 34 of the outer periphery 3a of the first IC chip 3 in plan view in the thickness direction D1 of the mounting substrate 2. More specifically, the input terminal 541 of the fourth power amplifier 54 is disposed on the main surface of the first IC chip 3 that faces the mounting substrate 2. The input terminal 541 of the fourth power amplifier 54 is disposed nearer than the first side 31, the second side 32, and the third side 33 to the fourth side 34 of the outer periphery 3a of the first IC chip 3 in plan view in the thickness direction D1 of the mounting substrate 2.

In the present specification, the phrase “the input terminal 541 of the fourth power amplifier 54 is disposed along the fourth side 34 of the outer periphery 3a of the first IC chip 3 in plan view in the thickness direction D1 of the mounting substrate 2” refers to the phrase “the input terminal 541 of the fourth power amplifier 54 is disposed nearer than the first side 31, the second side 32, and the third side 33 to the fourth side 34 of the outer periphery 3a of the first IC chip 3 in plan view in the thickness direction D1 of the mounting substrate 2”.

As illustrated in FIG. 1, the input terminal 551 of the fifth power amplifier 55 is disposed along the third side 33 of the outer periphery 3a of the first IC chip 3 in plan view in the thickness direction D1 of the mounting substrate 2. More specifically, the input terminal 551 of the fifth power amplifier 55 is disposed on the main surface of the first IC chip 3 that faces the mounting substrate 2. The input terminal 551 of the fifth power amplifier 55 is disposed nearer than the first side 31, the second side 32, and the fourth side 34 to the third side 33 of the outer periphery 3a of the first IC chip 3 in plan view in the thickness direction D1 of the mounting substrate 2.

As illustrated in FIG. 1, the secondary coil 72B of the fourth balun 7B intersects with the fourth side 34 and the third side 33 of the outer periphery 3a of the first IC chip 3 in plan view in the thickness direction D1 of the mounting substrate 2. More specifically, the fourth side 34 of the outer periphery 3a of the first IC chip 3 extends in the first direction D21 in plan view in the thickness direction D1 of the mounting substrate 2, but the first end of the secondary coil 72B extends in the second direction D22. Accordingly, the first end of the secondary coil 72B intersects with the fourth side 34 of the outer periphery 3a of the first IC chip 3 in plan view in the thickness direction D1 of the mounting substrate 2. The third side 33 of the outer periphery 3a of the first IC chip 3 extends in the second direction D22 in plan view in the thickness direction D1 of the mounting substrate 2, but the second end of the secondary coil 72B extends in the first direction D21. Accordingly, the second end of the secondary coil 72B intersects with the third side 33 of the outer periphery 3a of the first IC chip 3 in plan view in the thickness direction D1 of the mounting substrate 2.

### (4) Effects

The radio frequency module 1 according to the first embodiment includes the mounting substrate 2, the first IC chip 3, and the first balun 6A. The first IC chip 3 is disposed in or on the mounting substrate 2 and includes the first power amplifier 51 and the second power amplifier 52. The first balun 6A is disposed in or on the mounting substrate 2. The first balun 6A includes the primary coil 61A. The primary coil 61A is connected between the output terminal 512 of the first power amplifier 51 and the output terminal 522 of the second power amplifier 52. The outer periphery 3a of the first IC chip 3 has a polygonal shape in plan view in the thickness direction D1 of the mounting substrate 2 and has the first side 31 and the second side 32 that differ from each other. The output terminal 512 of the first power amplifier 51 is disposed along the first side 31 in plan view in the thickness direction D1 of the mounting substrate 2. The output terminal 522 of the second power amplifier 52 is disposed along the second side 32 in plan view in the thickness direction D1 of the mounting substrate 2. The primary coil 61A of the first balun 6A intersects with the first side 31 and the second side 32 in plan view in the thickness direction D1 of the mounting substrate 2.

The radio frequency module 1 according to the first embodiment enables the exclusive areas of a balun (the first balun 6A) and a power amplifier (the first power amplifier 51) to be reduced. That is, in the radio frequency module 1 according to the first embodiment, the first side 31 and the second side 32 are adjacent to each other in plan view in the thickness direction D1 of the mounting substrate 2. Therefore, the radio frequency module 1 according to the first embodiment enables the length of the first balun 6A to be reduced and accordingly enables the length of the first balun 6A to be optimized.

The radio frequency module 1 according to the first embodiment further includes the second IC chip 4 and the second balun 6B. The second IC chip 4 is disposed in or on the mounting substrate 2 and includes the third power amplifier 53. The second balun 6B is disposed in or on the mounting substrate 2. The third power amplifier 53 is connected to the input terminal 511 of the first power amplifier 51 and the input terminal 521 of the second power amplifier 52. The second balun 6B includes the primary coil 61B and the secondary coil 62B. The primary coil 61B is connected to the output terminal 532 of the third power amplifier 53. The secondary coil 62B is connected between the input terminal 511 of the first power amplifier 51 and the input terminal 521 of the second power amplifier 52. The outer periphery 3a of the first IC chip 3 further includes the third side 33 that faces away from the second side 32 in plan view in the thickness direction D1 of the mounting substrate 2. The input terminal 511 of the first power amplifier 51 is disposed along the first side 31 in plan view in the thickness direction D1 of the mounting substrate 2. The input terminal 521 of the second power amplifier 52 is disposed along the third side 33 in plan view in the thickness direction D1 of the mounting substrate 2. The secondary coil 62B of the second balun 6B intersects with the first side 31 and the third side 33 in plan view in the thickness direction D1 of the mounting substrate 2.

As for the radio frequency module 1 according to the first embodiment, the input terminal 511 of the first power amplifier 51 is disposed along the first side 31 in plan view in the thickness direction D1 of the mounting substrate 2, the input terminal 521 of the second power amplifier 52 is disposed along the third side 33, and the secondary coil 62B of the second balun 6B intersects with the first side 31 and the third side 33. This enables the exclusive areas of baluns (the first balun 6A and the second balun 6B) and power amplifiers (the first power amplifier 51 and the second power amplifier 52) to be further reduced.

### (5) Modifications

Modifications to the first embodiment will now be described.

### (5.1) First Modification

According to a first modification to the first embodiment, the first side 31 and the second side 32 of the outer periphery 3a of the first IC chip 3 need not be adjacent to each other in plan view in the thickness direction D1 of the mounting substrate 2. For example, the first side 31 and the second side 32 may face away from each other in plan view in the thickness direction D1 of the mounting substrate 2.

### (5.2) Second Modification

According to a second modification to the first embodiment, the secondary coil 62B of the second balun 6B is not limited to a structure in which the secondary coil 62B intersects with the first side 31 and the third side 33 of the outer periphery 3a of the first IC chip 3.

The radio frequency module 1 according to each modification described above exerts the same effects as the radio frequency module 1 according to the first embodiment.

### Second Embodiment

As illustrated in FIG. 4, the radio frequency module 1 according to the second embodiment differs from the radio frequency module 1 according to the first embodiment (see FIG. 1) in that the primary coil 71A of the third balun 7A is disposed inside the primary coil 61A of the first balun 6A. As for the radio frequency module 1 according to the second embodiment, components like those of the radio frequency module 1 according to the first embodiment are designated by using like reference characters, and the description thereof is omitted.

### (1) Structure

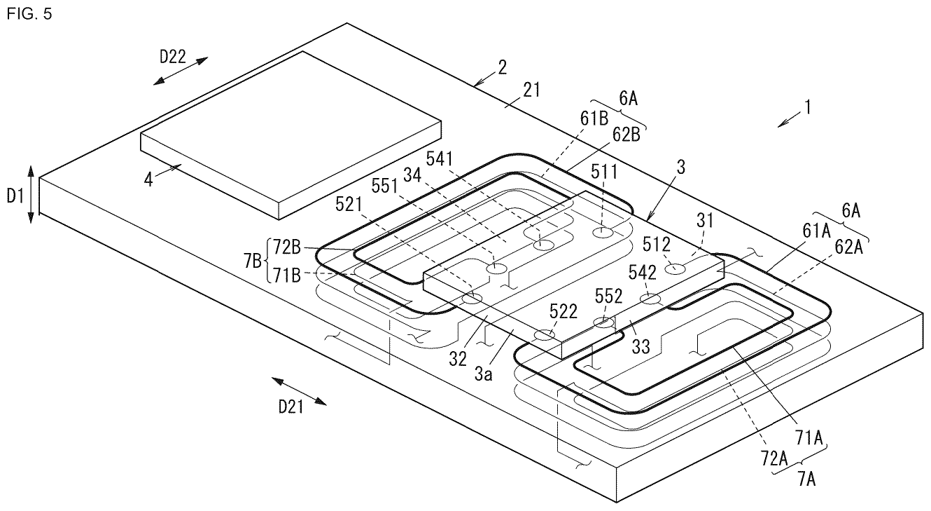

As illustrated in FIG. 4 and FIG. 5, the radio frequency module 1 according to the second embodiment includes the mounting substrate 2, the first IC chip 3, the second IC chip 4, the first balun 6A, the second balun 6B, the third balun 7A, and the fourth balun 7B. The radio frequency module 1 according to the second embodiment further includes the fifth balun 8A, the sixth balun 8B, the multiple external connection terminals 11, and the multiple (four in the example in FIG. 3) switches 12 to 15 as in the radio frequency module 1 according to the first embodiment (see FIG. 3).

### (2) Positional Relationship

As for the outer periphery 3a of the first IC chip 3 according to the second embodiment, as illustrated in FIG. 4, the first side 31 and the second side 32 face away from each other (e.g., may be on opposite sides of the first IC chip 3) in plan view in the thickness direction D1 (see FIG. 5) of the mounting substrate 2.

As illustrated in FIG. 4, the output terminal 512 of the first power amplifier 51 is disposed along the first side 31 of the outer periphery 3a of the first IC chip 3 in plan view in the thickness direction D1 of the mounting substrate 2. As illustrated in FIG. 4, the output terminal 522 of the second power amplifier 52 is disposed along the second side 32 of the outer periphery 3a of the first IC chip 3 in plan view in the thickness direction D1 of the mounting substrate 2.

As illustrated in FIG. 4, the primary coil 61A of the first balun 6A intersects with the first side 31 and the second side 32 of the outer periphery 3a of the first IC chip 3 in plan view in the thickness direction D1 of the mounting substrate 2.

As illustrated in FIG. 4, an additional coil (i.e., the primary coil 71A of the third balun 7A) is disposed inside (e.g., inside an inner perimeter of) the primary coil 61A of the first balun 6A in plan view in the thickness direction D1 of the mounting substrate 2. For example, referring to FIG. 4, the primary coil 61A of the first balun 6A may continuously extend around two corners of the first IC chip 3, and may surround the primary coil 71A of the third balun 7A, as viewed in plan view in the thickness direction D1 of the mounting substrate 2.

According to the second embodiment, as illustrated in FIG. 4, the output terminal 542 of the fourth power amplifier 54 and the output terminal 552 of the fifth power amplifier 55 are disposed along the third side 33 of the outer periphery 3a of the first IC chip 3 in plan view in the thickness direction D1 of the mounting substrate 2. The third side 33 is adjacent to the first side 31 and the second side 32.

According to the second embodiment, as illustrated in FIG. 4, the primary coil 71A of the third balun 7A intersects with the third side 33 of the outer periphery 3a of the first IC chip 3 in plan view in the thickness direction D1 of the mounting substrate 2.

According to the second embodiment, as illustrated in FIG. 4, the secondary coil 72B of the fourth balun 7B is disposed inside the secondary coil 62B of the second balun 6B in plan view in the thickness direction D1 of the mounting substrate 2.

As illustrated in FIG. 4, the input terminal 511 of the first power amplifier 51 is disposed along the first side 31 of the outer periphery 3a of the first IC chip 3 in plan view in the thickness direction D1 of the mounting substrate 2. As illustrated in FIG. 4, the input terminal 521 of the second power amplifier 52 is disposed along the second side 32 of the outer periphery 3a of the first IC chip 3 in plan view in the thickness direction D1 of the mounting substrate 2.

As illustrated in FIG. 4, the secondary coil 62B of the second balun 6B intersects with the first side 31 and the second side 32 of the outer periphery 3a of the first IC chip 3 in plan view in the thickness direction D1 of the mounting substrate 2.

According to the second embodiment, as illustrated in FIG. 4, the input terminal 541 of the fourth power amplifier 54 and the input terminal 551 of the fifth power amplifier 55 are disposed along the fourth side 34 of the outer periphery 3a of the first IC chip 3 in plan view in the thickness direction D1 of the mounting substrate 2. The fourth side 34 is adjacent to the first side 31 and the second side 32 and faces away from the third side 33.

As illustrated in FIG. 4, the secondary coil 72B of the fourth balun 7B intersects with the fourth side 34 of the outer periphery 3a of the first IC chip 3 in plan view in the thickness direction D1 of the mounting substrate 2.

### (3) Effects

The radio frequency module 1 according to the second embodiment enables the exclusive areas of a balun (the first balun 6A) and a power amplifier (the first power amplifier 51) to be reduced as in the radio frequency module 1 according to the first embodiment.

As for the radio frequency module 1 according to the second embodiment, the first side 31 and the second side 32 face away from each other in plan view in the thickness direction D1 of the mounting substrate 2.

The radio frequency module 1 according to the second embodiment enables the length of the first balun 6A (the primary coil 61A) to be increased and enables the length of the first balun 6A to be optimized.

The radio frequency module 1 according to the second embodiment further includes the third balun 7A. The third balun 7A is disposed in or on the mounting substrate 2. The first power amplifier 51 and the second power amplifier 52 amplify the transmission signal at the first frequency. The first IC chip 3 further includes the fourth power amplifier 54 and the fifth power amplifier 55. The fourth power amplifier 54 and the fifth power amplifier 55 amplify the transmission signal at the second frequency higher than the first frequency. The third balun 7A includes the primary coil 71A. The primary coil 71A is connected between the output terminal 542 of the fourth power amplifier 54 and the output terminal 552 of the fifth power amplifier 55. The primary coil 71A of the third balun 7A is disposed inside the primary coil 61A of the first balun 6A in plan view in the thickness direction D1 of the mounting substrate 2.

As for the radio frequency module 1 according to the second embodiment, the primary coil 71A of the third balun 7A is disposed inside the primary coil 61A of the first balun 6A in plan view in the thickness direction D1 of the mounting substrate 2. This enables the exclusive areas of baluns (the first balun 6A and the third balun 7A) to be further reduced.

As for the radio frequency module 1 according to the second embodiment, the output terminal 542 of the fourth power amplifier 54 and the output terminal 552 of the fifth power amplifier 55 are disposed along the third side 33 that is adjacent to the first side 31 and the second side 32 in plan view in the thickness direction D1 of the mounting substrate 2. The primary coil 71A of the third balun 7A intersects with the third side 33 in plan view in the thickness direction D1 of the mounting substrate 2.

The radio frequency module 1 according to the second embodiment enables the length of the primary coil 71A of the third balun 7A to be reduced.

The radio frequency module 1 according to the second embodiment further includes a third IC chip and the fourth balun 7B. According to the second embodiment, the second IC chip 4 doubles as the third IC chip. The third IC chip (the second IC chip 4) is disposed in or on the mounting substrate 2. The third IC chip includes the sixth power amplifier 56. The fourth balun 7B is disposed in or on the mounting substrate 2. The fourth balun 7B includes the primary coil 71B and the secondary coil 72B. The primary coil 71B is connected to the output terminal 562 of the sixth power amplifier 56. The secondary coil 72B is connected between the input terminal 541 of the fourth power amplifier 54 and the input terminal 551 of the fifth power amplifier 55. The secondary coil 72B of the fourth balun 7B is disposed inside the secondary coil 62B of the second balun 6B in plan view in the thickness direction D1 of the mounting substrate 2.

The radio frequency module 1 according to the second embodiment enables the exclusive area of a balun (the fourth balun 7B) to be further reduced.

As for the radio frequency module 1 according to the second embodiment, the input terminal 541 of the fourth power amplifier 54 and the input terminal 551 of the fifth power amplifier 55 are disposed along the fourth side 34 in plan view in the thickness direction D1 of the mounting substrate 2. The secondary coil 72B of the fourth balun 7B intersects with the fourth side 34 in plan view in the thickness direction D1 of the mounting substrate 2.

The radio frequency module 1 according to the second embodiment enables the length of the secondary coil 72B of the fourth balun 7B to be reduced.

### (4) Modifications

Modifications to the second embodiment will now be described.

### (4.1) First Modification

According to a first modification to the second embodiment, the primary coil 71A of the third balun 7A need not be disposed inside the primary coil 61A of the first balun 6A in plan view in the thickness direction D1 of the mounting substrate 2.

### (4.2) Second Modification

According to a second modification to the second embodiment, the output terminal 542 of the fourth power amplifier 54 and the output terminal 552 of the fifth power amplifier 55 need not be disposed along the third side 33 in plan view in the thickness direction D1 of the mounting substrate 2.

### (4.3) Third Modification

According to a third modification to the second embodiment, the secondary coil 72B of the fourth balun 7B need not be disposed inside the secondary coil 62B of the second balun 6B in plan view in the thickness direction D1 of the mounting substrate 2.

### (4.4) Fourth Modification

According to a fourth modification to the second embodiment, the input terminal 541 of the fourth power amplifier 54 and the input terminal 551 of the fifth power amplifier 55 need not be disposed along the fourth side 34 in plan view in the thickness direction D1 of the mounting substrate 2.

Also the radio frequency module 1 according to each modification described above enables the exclusive areas of a balun and a power amplifier to be reduced as in the radio frequency module 1 according to the second embodiment.

### Third Embodiment

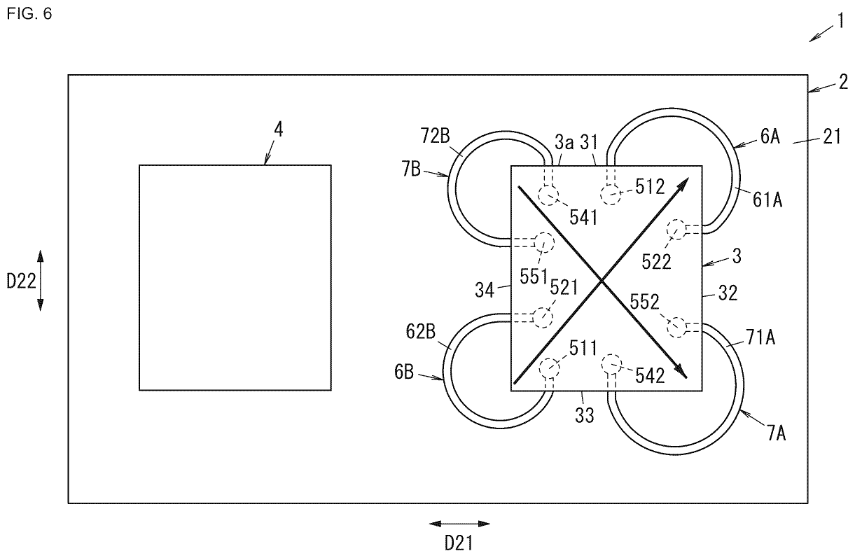

As illustrated in FIG. 6, the radio frequency module 1 according to the third embodiment differs from the radio frequency module 1 according to the first embodiment (see FIG. 1) in that the first balun 6A and the second balun 6B are disposed on a diagonal line. As for the radio frequency module 1 according to the third embodiment, components like those of the radio frequency module 1 according to the first embodiment are designated by using like reference characters, and the description thereof is omitted.

### (1) Structure

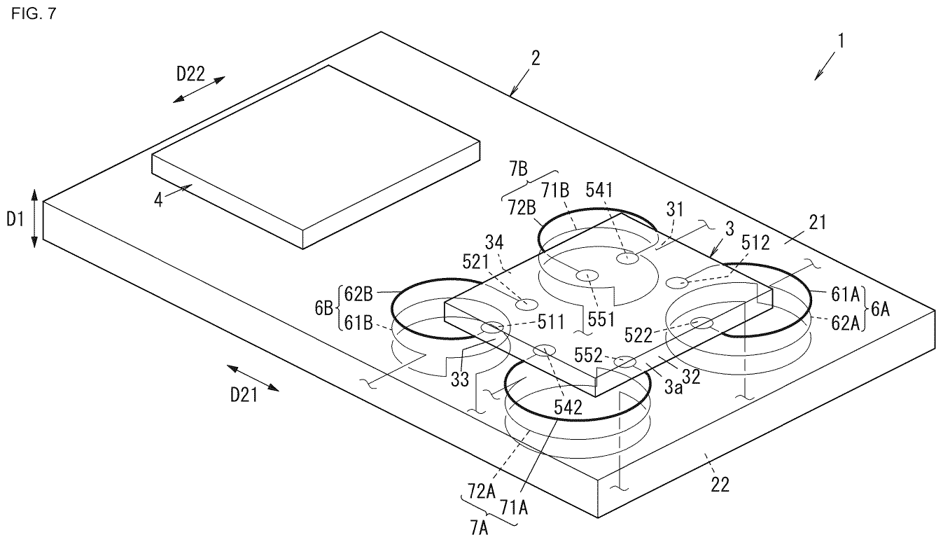

As illustrated in FIG. 6 and FIG. 7, the radio frequency module 1 according to the third embodiment includes the mounting substrate 2, the first IC chip 3, the second IC chip 4, the first balun 6A, the second balun 6B, the third balun 7A, and the fourth balun 7B. The radio frequency module 1 according to the third embodiment further includes the fifth balun 8A, the sixth balun 8B, and the multiple external connection terminals 11 as in the radio frequency module 1 according to the first embodiment.

The outer periphery 3a of the first IC chip 3 according to the third embodiment has a polygonal shape in plan view in the thickness direction D1 of the mounting substrate 2. The outer periphery 3a of the first IC chip 3 has the first side 31, the second side 32, the third side 33, and the fourth side 34.

According to the third embodiment, the first side 31 and the second side 32 are adjacent to each other in plan view in the thickness direction D1 of the mounting substrate 2. The third side 33 faces away from the first side 31 in plan view in the thickness direction D1 of the mounting substrate 2. The fourth side 34 faces away from the second side 32 in plan view in the thickness direction D1 of the mounting substrate 2.

### (2) Positional Relationship

As illustrated in FIG. 6, the output terminal 512 of the first power amplifier 51 is disposed along the first side 31 of the outer periphery 3a of the first IC chip 3 in plan view in the thickness direction D1 of the mounting substrate 2. As illustrated in FIG. 1, the output terminal 522 of the second power amplifier 52 is disposed along the second side 32 of the outer periphery 3a of the first IC chip 3 in plan view in the thickness direction D1 of the mounting substrate 2.

According to the third embodiment, as illustrated in FIG. 6, the input terminal 511 of the first power amplifier 51 is disposed along the third side 33 of the outer periphery 3a of the first IC chip 3 in plan view in the thickness direction D1 of the mounting substrate 2. As illustrated in FIG. 6, the input terminal 521 of the second power amplifier 52 is disposed along the fourth side 34 of the outer periphery 3a of the first IC chip 3 in plan view in the thickness direction D1 of the mounting substrate 2.

As illustrated in FIG. 6, the secondary coil 62B of the second balun 6B intersects with the third side 33 and the fourth side 34 of the outer periphery 3a of the first IC chip 3 in plan view in the thickness direction D1 of the mounting substrate 2.

As illustrated in FIG. 6, the output terminal 542 of the fourth power amplifier 54 is disposed along the third side 33 of the outer periphery 3a of the first IC chip 3 in plan view in the thickness direction D1 of the mounting substrate 2. As illustrated in FIG. 6, the output terminal 552 of the fifth power amplifier 55 is disposed along the second side 32 of the outer periphery 3a of the first IC chip 3 in plan view in the thickness direction D1 of the mounting substrate 2.

As illustrated in FIG. 6, the primary coil 71A of the third balun 7A intersects with the third side 33 and the second side 32 of the outer periphery 3a of the first IC chip 3 in plan view in the thickness direction D1 of the mounting substrate 2.

As illustrated in FIG. 6, the input terminal 541 of the fourth power amplifier 54 is disposed along the first side 31 of the outer periphery 3a of the first IC chip 3 in plan view in the thickness direction D1 of the mounting substrate 2. As illustrated in FIG. 6, the input terminal 551 of the fifth power amplifier 55 is disposed along the fourth side 34 of the outer periphery 3a of the first IC chip 3 in plan view in the thickness direction D1 of the mounting substrate 2.

As illustrated in FIG. 6, the secondary coil 72B of the fourth balun 7B intersects with the first side 31 and the fourth side 34 of the outer periphery 3a of the first IC chip 3 in plan view in the thickness direction D1 of the mounting substrate 2.

### (3) Effects

The radio frequency module 1 according to the third embodiment enables the exclusive area of a balun (the first balun 6A) and a power amplifier (the first power amplifier 51) to be reduced as in the radio frequency module 1 according to the first embodiment.

The radio frequency module 1 according to the third embodiment further includes the second IC chip 4 and the second balun 6B. The second IC chip 4 is disposed in or on the mounting substrate 2 and includes the third power amplifier 53. The second balun 6B is disposed in or on the mounting substrate 2. The third power amplifier 53 is connected to the input terminal 511 of the first power amplifier 51 and the input terminal 521 of the second power amplifier 52. The second balun 6B includes the primary coil 61B and the secondary coil 62B. The primary coil 61B is connected to the output terminal 532 of the third power amplifier 53. The secondary coil 62B is connected between the input terminal 511 of the first power amplifier 51 and the input terminal 521 of the second power amplifier 52. The outer periphery 3a of the first IC chip 3 further has the third side 33 that faces away from the first side 31 and the fourth side 34 that faces away from the second side 32 in plan view in the thickness direction D1 of the mounting substrate 2. The input terminal 511 of the first power amplifier 51 is disposed along the third side 33 in plan view in the thickness direction D1 of the mounting substrate 2. The input terminal 521 of the second power amplifier 52 is disposed along the fourth side 34 in plan view in the thickness direction D1 of the mounting substrate 2. The secondary coil 62B of the second balun 6B intersects with the third side 33 and the fourth side 34 in plan view in the thickness direction D1 of the mounting substrate 2.

As for the radio frequency module 1 according to the third embodiment, the input terminal 511 of the first power amplifier 51 is disposed along the third side 33 in plan view in the thickness direction D1 of the mounting substrate 2, the input terminal 521 of the second power amplifier 52 is disposed along the fourth side 34, and the secondary coil 62B of the second balun 6B intersects with the third side 33 and the fourth side 34. Consequently, the input terminal 511 and the output terminal 512 of the first power amplifier 51 can be separated from each other, and the input terminal 521 and the output terminal 522 of the second power amplifier 52 can be separated from each other. This enables isolation to be improved.

### Fourth Embodiment

According to the fourth embodiment, the communication device 9 that includes a radio frequency module 1 will be described with reference to the drawings.

### (1) Effects

As illustrated in FIG. 8, the communication device 9 according to the fourth embodiment includes the radio frequency module 1, the multiple (two in an example in FIG. 8) antennas 911 and 912, and the signal processing circuit 92. For example, the communication device 9 is a mobile terminal (such as a smartphone). The communication device 9 is not limited to a mobile terminal, but may be, for example, a wearable terminal (such as a smartwatch).

The radio frequency module 1 according to the fourth embodiment has the same structure as the radio frequency module 1 according to the first embodiment. As for the radio frequency module 1 according to the fourth embodiment, components like those of the radio frequency module 1 according to the first embodiment are designated by using like reference characters, and the description thereof is omitted.

The radio frequency module 1 amplifies transmission signals (radio frequency signals) from the signal processing circuit 92 and outputs the signals to the antennas 911 and 912. The radio frequency module 1 amplifies reception signals (radio frequency signals) that are received by the antennas 911 and 912 and outputs the signals to the signal processing circuit 92. For example, the radio frequency module 1 is controlled by the signal processing circuit 92.

For example, the radio frequency module 1 conforms to the second generation mobile communication (2G) standard, a fourth generation mobile communication (4G) standard, and the fifth generation mobile communication (5G) standard. Examples of the 4G standard include Third Generation Partnership Project (3GPP, registered trademark) and a Long Term Evolution (LTE, registered trademark) standard. An example of the 5G standard is 5G New Radio (NR). The radio frequency module 1 supports carrier aggregation and dual connectivity.

As for the communication device 9, the radio frequency module 1 is electrically connectable to an external substrate. For example, the external substrate corresponds to the motherboard of, for example, a mobile terminal or communication equipment. The case where the radio frequency module 1 is electrically connectable to the external substrate includes not only the case where the radio frequency module 1 is directly mounted to the external substrate but also the case where the radio frequency module 1 is indirectly mounted to the external substrate. Examples of the case where the radio frequency module 1 is indirectly mounted to the external substrate include the case where the radio frequency module 1 is mounted to another radio frequency module that is mounted to the external substrate.

### (1.1) Antenna

The antenna 911 illustrated in FIG. 8 is connected to the antenna terminal 171 (see FIG. 3) of the radio frequency module 1. The antenna 911 has a transmission function of radiating, as a radio wave, a transmission signal that is outputted from the radio frequency module 1.

The antenna 912 illustrated in FIG. 8 is connected to the antenna terminal 172 (see FIG. 3) of the radio frequency module 1. The antenna 912 has a transmission function of radiating, as a radio wave, a transmission signal that is outputted from the radio frequency module 1.

### (1.2) Signal Processing Circuit

As illustrated in FIG. 8, the signal processing circuit 92 is connected to the radio frequency module 1. The signal processing circuit 92 processes a radio frequency signal that passes through the radio frequency module 1. More specifically, the signal processing circuit 92 processes a transmission signal to be outputted to the radio frequency module 1. The signal processing circuit 92 processes a reception signal that is received from the radio frequency module 1.

The signal processing circuit 92 includes a baseband signal processing circuit 93 and the RF signal processing circuit 94.

For example, the baseband signal processing circuit 93 is a baseband integrated circuit (BBIC).

The baseband signal processing circuit 93 performs predetermined signal processing on a signal from a location outside the signal processing circuit 92. More specifically, the baseband signal processing circuit 93 generates a transmission signal from a baseband signal (such as a voice signal or an image signal) from a location outside the signal processing circuit 92 and outputs the generated transmission signal to the RF signal processing circuit 94.

The baseband signal processing circuit 93 performs predetermined signal processing on a signal from the RF signal processing circuit 94. More specifically, the baseband signal processing circuit 93 outputs a reception signal that is received from the RF signal processing circuit 94 to the outside. For example, the reception signal that is processed by the baseband signal processing circuit 93 is used as an image signal for image display or a voice signal for a phone call.

For example, the RF signal processing circuit 94 is a radio frequency integrated circuit (RFIC) and performs signal processing on radio frequency signals (a transmission signal and a reception signal).

The RF signal processing circuit 94 performs signal processing on a transmission signal that is outputted from the baseband signal processing circuit 93 and outputs a processed transmission signal to the radio frequency module 1. Specifically, the RF signal processing circuit 94 performs signal processing such as up-converting on the transmission signal that is outputted from the baseband signal processing circuit 93 and outputs a processed transmission signal to a transmission path of the radio frequency module 1.

The RF signal processing circuit 94 performs signal processing on a reception signal that is outputted from the radio frequency module 1 and outputs a processed reception signal to the baseband signal processing circuit 93. Specifically, the RF signal processing circuit 94 performs signal processing such as down-converting on a reception signal that is outputted from a reception path of the radio frequency module 1 and outputs a processed reception signal to the baseband signal processing circuit 93.

### (2) Effects

The communication device 9 according to the fourth embodiment includes the radio frequency module 1 and the signal processing circuit 92. The signal processing circuit 92 is connected to the radio frequency module 1.

As for the radio frequency module 1 of the communication device 9 according to the fourth embodiment, the output terminal 512 of the first power amplifier 51 is disposed along the first side 31 in plan view in the thickness direction D1 of the mounting substrate 2, the output terminal 522 of the second power amplifier 52 is disposed along the second side 32, and the primary coil 61A of the first balun 6A intersects with the first side 31 and the second side 32. This enables the exclusive area of a balun (the first balun 6A) and a power amplifier (the first power amplifier 51) to be reduced.

### (3) Modification

A modification to the fourth embodiment will now be described.

The communication device 9 according to the modification to the fourth embodiment may include the radio frequency module 1 according to the second or third embodiment, the radio frequency module 1 according to the modification to the second embodiment, or the radio frequency module 1 according to the modification to the third embodiment instead of the radio frequency module 1 according to the first embodiment.

Also the communication device 9 according to the modification described above exerts the same effects as the communication device 9 according to the fourth embodiment.

The embodiments and the modifications described above are only some of various embodiments and modifications according to the present disclosure. The embodiments and the modifications can be changed in various ways depending on, for example, design, provided that aspects of the present disclosure are achieved.

By way of summation and review, a communication device according to an aspect of the present disclosure includes a radio frequency module and a signal processing circuit. The signal processing circuit is connected to the radio frequency module. The radio frequency module and the communication device according to the aspects of the described present disclosure above enable the exclusive areas of a balun and a power amplifier to be reduced.

What is claimed is:

1. A radio frequency module, comprising:
a mounting substrate;
a first IC chip in or on the mounting substrate, the first IC chip including a first power amplifier and a second power amplifier; and
a first balun in or on the mounting substrate, the first balun including a primary coil connected between an output terminal of the first power amplifier and an output terminal of the second power amplifier,
wherein an outer periphery of the first IC chip has a polygonal shape in a plan view in a thickness direction of the mounting substrate, the polygonal shape having a first side and a second side that differ from each other,
wherein the output terminal of the first power amplifier is disposed along the first side in the plan view in the thickness direction of the mounting substrate,
wherein the output terminal of the second power amplifier is disposed along the second side in the plan view in the thickness direction of the mounting substrate, and
wherein the primary coil of the first balun intersects with the first side and the second side in the plan view in the thickness direction of the mounting substrate.

2. The radio frequency module according to claim 1, wherein the first side and the second side are adjacent to each other in the plan view in the thickness direction of the mounting substrate.

3. The radio frequency module according to claim 2, further comprising:
a second IC chip in or on the mounting substrate, the second IC chip including a third power amplifier; and
a second balun in or on the mounting substrate,
wherein the third power amplifier is connected to an input terminal of the first power amplifier and an input terminal of the second power amplifier,
wherein the second balun includes a primary coil that is connected to an output terminal of the third power amplifier, and a secondary coil that is connected between the input terminal of the first power amplifier and the input terminal of the second power amplifier,
wherein the outer periphery of the first IC chip further includes a third side that faces away from the second side in the plan view in the thickness direction of the mounting substrate,
wherein the input terminal of the first power amplifier is disposed along the first side in the plan view in the thickness direction of the mounting substrate,
wherein the input terminal of the second power amplifier is disposed along the third side in the plan view in the thickness direction of the mounting substrate, and
wherein the secondary coil of the second balun intersects with the first side and the third side in the plan view in the thickness direction of the mounting substrate.

4. The radio frequency module according to claim 2, further comprising:
a second IC chip in or on the mounting substrate, the second IC chip including a third power amplifier; and
a second balun in or on the mounting substrate,
wherein the third power amplifier is connected to an input terminal of the first power amplifier and an input terminal of the second power amplifier,
wherein the second balun includes a primary coil that is connected to an output terminal of the third power amplifier, and a secondary coil that is connected between the input terminal of the first power amplifier and the input terminal of the second power amplifier,
wherein the outer periphery of the first IC chip further includes a third side that faces away from the first side and a fourth side that faces away from the second side in the plan view in the thickness direction of the mounting substrate,
wherein the input terminal of the first power amplifier is disposed along the third side in the plan view in the thickness direction of the mounting substrate,
wherein the input terminal of the second power amplifier is disposed along the fourth side in the plan view in the thickness direction of the mounting substrate, and
wherein the secondary coil of the second balun intersects with the third side and the fourth side in the plan view in the thickness direction of the mounting substrate.

5. The radio frequency module according to claim 1, wherein the first side and the second side face away from each other in the plan view in the thickness direction of the mounting substrate.

6. The radio frequency module according to claim 5, further comprising:
a second balun in or on the mounting substrate; and
a third balun in or on the mounting substrate,
wherein the first power amplifier and the second power amplifier amplify a transmission signal at a first frequency,
wherein the first IC chip further includes a fourth power amplifier and a fifth power amplifier that amplify a transmission signal at a second frequency higher than the first frequency,
wherein the third balun includes a primary coil that is connected between an output terminal of the fourth power amplifier and an output terminal of the fifth power amplifier, and
wherein the primary coil of the third balun is inside the primary coil of the first balun in the plan view in the thickness direction of the mounting substrate.

7. The radio frequency module according to claim 6, wherein:
the output terminal of the fourth power amplifier and the output terminal of the fifth power amplifier are disposed along a third side that is adjacent to the first side and the second side in the plan view in the thickness direction of the mounting substrate, and
the primary coil of the third balun intersects with the third side in plan view in the thickness direction of the mounting substrate.

8. The radio frequency module according to claim 7, further comprising:
a third IC chip in or on the mounting substrate, the third IC chip including a sixth power amplifier; and
a fourth balun in or on the mounting substrate,
wherein the fourth balun includes a primary coil that is connected to an output terminal of the sixth power amplifier, and a secondary coil that is connected between an input terminal of the fourth power amplifier and an input terminal of the fifth power amplifier, and
wherein the secondary coil of the fourth balun is disposed inside a secondary coil of the second balun in the plan view in the thickness direction of the mounting substrate.

9. The radio frequency module according to claim 8, wherein:
the input terminal of the fourth power amplifier and the input terminal of the fifth power amplifier are disposed along a fourth side that faces away from the third side in plan view in the thickness direction of the mounting substrate, and
wherein the secondary coil of the fourth balun intersects with the fourth side in plan view in the thickness direction of the mounting substrate.

10. A communication device, comprising:
the radio frequency module according to claim 1; and
a signal processing circuit that is connected to the radio frequency module.

11. The radio frequency module according to claim 1, wherein:
a distance between the output terminal of the first power amplifier and the first side is smaller than a distance between the output terminal of the first power amplifier and each of other sides of the polygonal shape of the first IC chip, and
a distance between the output terminal of the second power amplifier and the second side is smaller than a distance between the output terminal of the second power amplifier and each of other sides of the polygonal shape of the first IC chip.

12. The radio frequency module according to claim 1, wherein:
a distance between the output terminal of the first power amplifier to the first side is different from a distance between the output terminal of the second power amplifier to the first side, and
a distance between the output terminal of the first power amplifier to the second side is different from a distance between the output terminal of the second power amplifier to the second side.

13. The radio frequency module according to claim 1, wherein the primary coil extends from the output terminal of the first power amplifier and surrounds at least one corner of the first IC chip.

14. The radio frequency module according to claim 13, wherein the primary coil surrounds a single corner of the first IC chip that connects between the first side and the second side.

15. The radio frequency module according to claim 13, wherein:
the primary coil is connected between opposite sides of the first IC chip, the primary coil surrounding two corners of the first IC chip, and
the radio frequency module further includes an additional primary coil connected to the first IC chip, the primary coil surrounding the additional primary coil.
